(19) United States
(12) Patent Application Publication
(10) Pub. No.: US 2013/0264367 A1
(43) Pub. Date: Oct. 10, 2013

(54) CARGO CARRIER FOR ATTACHMENT TO A VEHICLE TRAILER HITCH

(71) Applicant: Curt J. Hill, Warba, MN (US)

(72) Inventor: Curt J. Hill, Warba, MN (US)

(21) Appl. No.: 13/442,016

(22) Filed: Apr. 9, 2012

(51) Int. Cl. B60R 9/06; B62J 11/00; B60R 9/10

(52) U.S. Cl. 224/413; 224/505

(57) ABSTRACT

A cargo carrier is operatively connected to a horizontally disposed hitch receiver tube secured to the rearward end of a vehicle with the cargo carrier being adapted to be moved from various positions between a position wherein it is parallel to the bed of the truck to a position wherein it is positioned well above the bed of the truck.

### BACKGROUND OF THE INVENTION

1. Field of the Invention

This invention relates to a cargo carrier which is secured to a trailer hitch mounted at the rearward end of a vehicle. More particularly, this invention relates to a cargo carrier which may be selectively moved angularly upwardly with respect to the trailer hitch. Even more particularly, this invention relates to a cargo carrier with the cargo carrier support being able to be folded flat, or removed and replaced with a bike rack.

2. Description of the Related Art

Many types of cargo carriers have been previously provided which may be attached to and supported by a trailer hitch secured to the rearward end of a vehicle. In most cargo carrier designs, the cargo carrier is positioned rearwardly of the vehicle at about the same level as the trailer hitch which results in the cargo on the carrier being subjected to road grime, rocks, mud, etc. In some cargo carrier designs, the cargo is supported at a level somewhat above the trailer hitch but those designs do not permit the cargo carrier to be selectively adjustably raised or lowered with respect to the vehicle and trailer hitch.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A cargo carrier is described for attachment to a vehicle trailer hitch including horizontally disposed hitch receiver tube. The cargo carrier of this invention includes an elongated first tube, having forward and rearward ends, with the rearward end thereof selectively received in a detachably secured to the hitch receiver tube. A first mounting structure is secured to the first tube adjacent the rearward end thereof which extends upwardly therefrom. An elongated second tube, having forward and rearward ends, has its forward end selectively adjustably pivotally secured to the first mount structure about a horizontal axis which is transverse to the longitudinal axis of the first and second tubes. A second mounting structure is secured to the second tube adjacent the rearward end thereof which extends upwardly therefrom. A third elongated tube is provided having first and second ends with the first end thereof being selectively adjustably pivotally secured to the second mount. A fourth elongated tube having first and second ends is also provided with the first end thereof being selectively rotatably secured to the third tube. A fifth elongated tube having first and second ends is also provided with the fifth elongated tube being secured, intermediate its first and second ends, to the second end of the fourth tube so as to be transversely disposed with respect to the fourth tube. A sixth tube is also provided which has first and second ends with the sixth tube being secured intermediate its first and second ends to the first end of the fifth tube so as to be disposed transversely thereto. The invention also includes a seventh tube having first and second ends with the first end of the seventh tube being selectively rotatably secured to the first end of the sixth tube so as to extend therefrom in a parallel manner thereto. The structure also includes an eighth tube having first and second ends with the first end of the eighth tube being secured to the second end of the seventh tube and which extends transversely therefrom. A ninth tube is provided having first and second ends with the first end of the ninth tube being selectively rotatably secured to the second end of the sixth tube so as to extend therefrom in a parallel manner thereto. The structure also includes a tenth tube having first and second ends with the first end of the tenth tube being secured to the second end of the ninth tube which extends transversely therefrom. An eleventh elongated tube having first and second ends is also utilized with the eleventh elongated tube being secured, intermediate the first and second ends thereof, to the second end of the fifth tube so as to be transversely disposed with respect to the fifth tube. A twelfth tube is also provided which has first and second ends. The first end of the twelfth tube is selectively rotatably secured to the first end of the eleventh tube so as to extend therefrom in a parallel manner thereto. A thirteenth tube having first and second ends is also utilized in the structure with the first end of the thirteenth tube being secured to the second end of the twelfth tube which extends transversely therefrom. A fourteenth tube is also provided, having first and second ends, with the first end thereof being selectively rotatably secured to the second end of the eleventh tube so as to extend therefrom in a parallel manner. A fifteenth tube, having first and second ends, is also provided with the first end of the fifteenth tube being secured to the second end of the fourteenth tube and which extends transversely therefrom.

It is therefore a principal object of the invention to provide a cargo carrier for attachment to a vehicle trailer hitch wherein the cargo carrier may be moved from a position directly in line with the vehicle trailer hitch to a position well above the vehicle trailer hitch and positioned therebetween.

A further object of the invention is to provide a cargo carrier of the type described including a cargo carrier structure which may be folded upon itself.

A further object of the invention is to provide a cargo carrier which enables the cargo carrier to be elevated above the vehicle trailer hitch so as to at least partially avoid road grime.

A further object of the invention is to provide a cargo carrier including various pivotal members and rotatable members which enables the cargo carrier to be placed in various different positions.

A further object of the invention is to provide a cargo carrier which extends angularly upwardly from the trailer hitch which maintains the load closer to the rear of the vehicle thus eliminating unnecessary overhang.

A further object of the invention is to provide a cargo carrier which extends angularly upwardly from the trailer hitch so that the load is raised above the tail lights of the vehicle thus eliminating a safety hazard or the need for additional lights.

Yet another object of the invention is to provide a cargo carrier with the cargo carrier support thereof being able to be folded flat, or removed and replaced with a bike rack.

Still another object of the invention is to provide a cargo carrier which may be secured to a truck, an automobile or a motorcycle.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is an exploded perspective view of the cargo carrier of this invention;

FIG. 2 is a partial exploded perspective view of the cargo carrier of this invention with the cargo support structure in a folded flat position;

FIG. 3 is a rear view of the cargo carrier of this invention with the cargo support structure being in an elevated position;

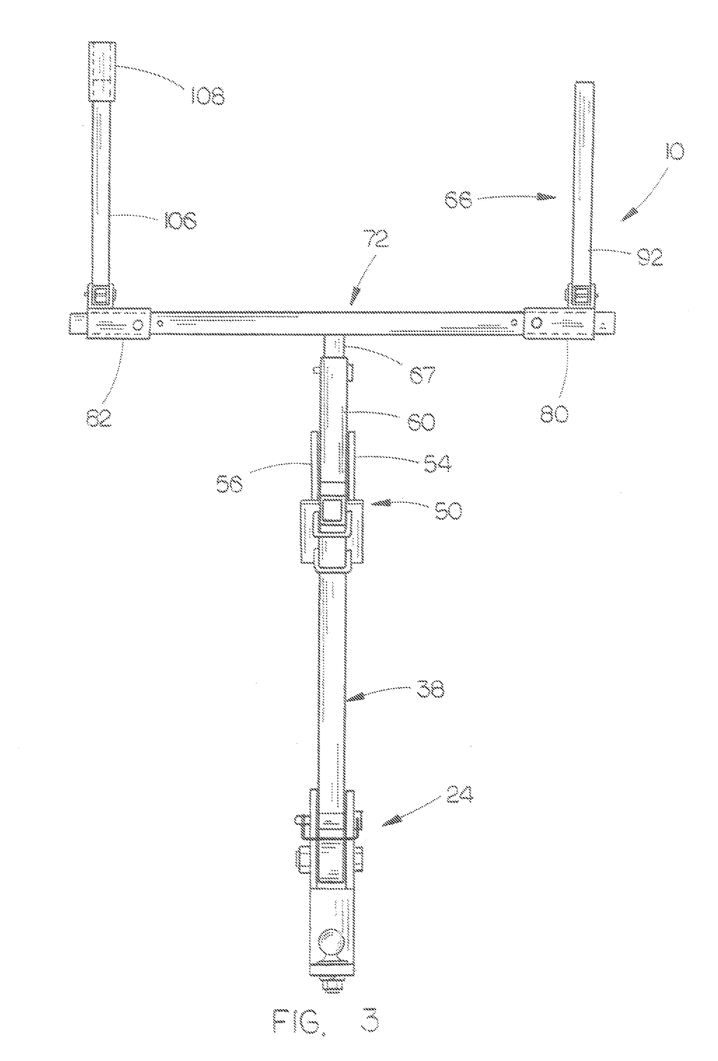

FIG. 4 is a side view of the cargo carrier of this invention mounted on the hitch receiver tube which is secured to a vehicle such as a pick-up truck.

FIG. 5 is a rear perspective view of the cargo carrier of this invention mounted on the hitch receiver tube which is secured to a pick-up truck having the tail gate thereof in a lowered position;

FIG. 6 is a side view of the cargo carrier of this invention in its most elevated position with respect to the vehicle;

FIG. 7 is a side view of the cargo carrier of this invention in a position wherein the cargo support structure is in the same plane as the tail gate of the truck; and

FIG. 8 is a side view similar to FIG. 7 except that the cargo carrier support has been rotated 90 degrees.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The cargo carrier of this invention is referred to by the reference numeral 10 and which is adapted to be secured to the receiver hitch tube 12 at the rearward end of a vehicle such as a truck 14 having a tailgate 15 at the rearward end thereof. Carrier 10 may also be secured to a receiver hitch tube mounted on the rearward end of an automobile or motorcycle. Carrier 10 includes an elongated tube 16 having a forward end 18 and a rearward end 20. Tube 16 is adapted to be received by the receiver hitch tube 12 and secured thereto in conventional fashion. Preferably, a hitch 22 is secured to the rearward end 20 of tube 16 to enable the vehicle to also pull a trailer or the like.

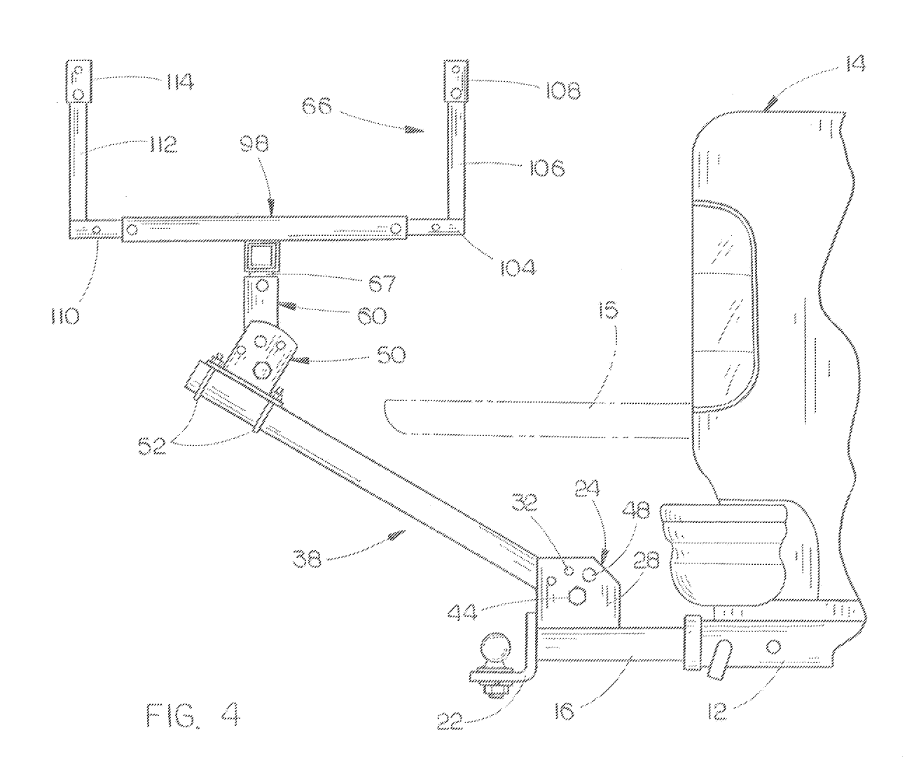

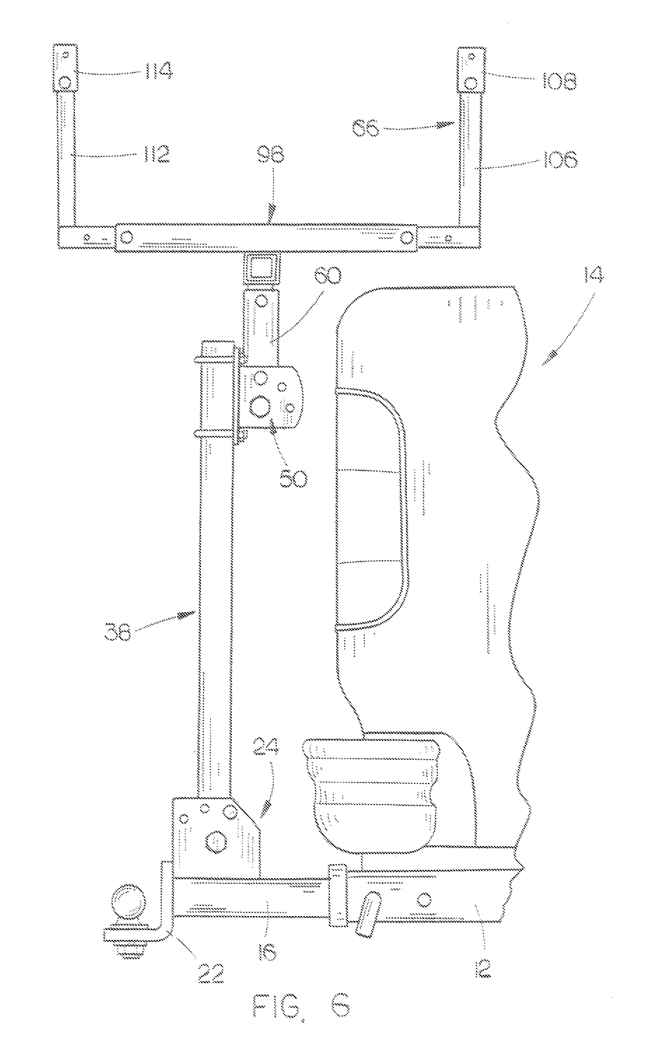

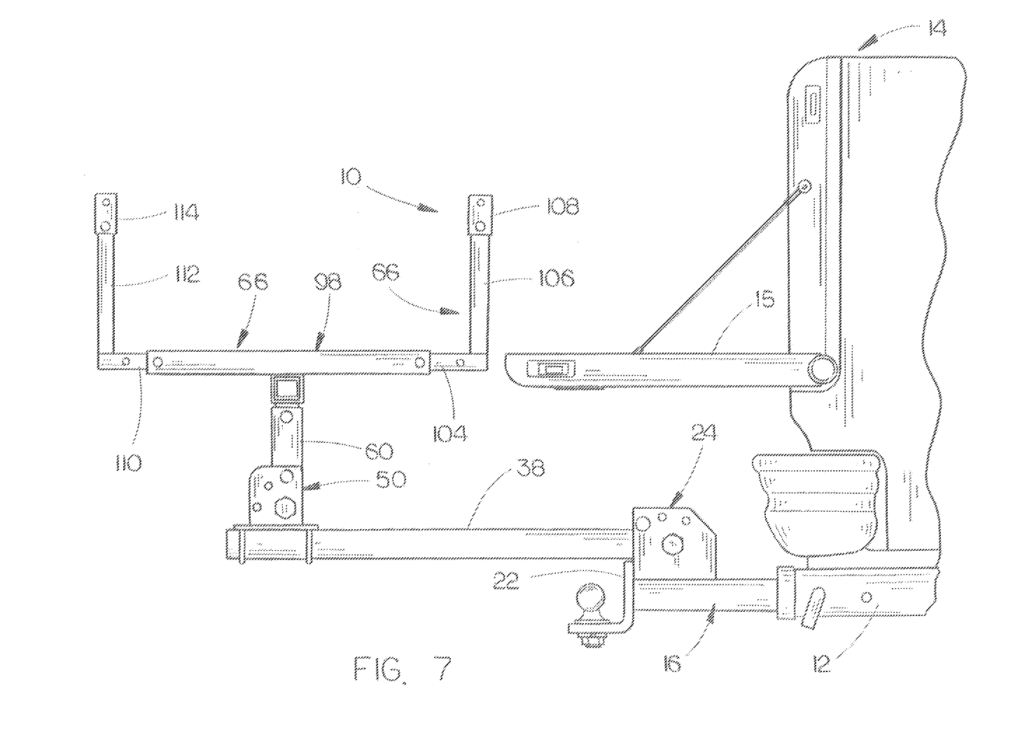

A mount assembly or mount 24 is secured to the rearward end of tube 16 with the mount 24 being comprised of a pair of spaced-apart, upstanding plates 26 and 28. Each of the plates 26 and 28 has a plurality of radially spaced-apart pin openings 30 and 32 formed therein respectively. Plates 26 and 28 also have aligned pivot pin openings 34 and 36 formed therein respectively. An elongated tube 38 having a sleeve 40 at its forward end 42 is selectively pivotally secured to plates 26 and 28 by a pivot pin or bolt 44 which extends through opening 34 in plate 26, through sleeve 40 and through opening 36 in plate 28. Tube 38 may be selectively pivoted with respect to mount 24 from a horizontal position (FIG. 7), to an upwardly and rearwardly extending position (FIG. 4), or to a vertically disposed position (FIG. 6). Tube 38 also has a collar 46 secured to its forward end. The tube 38 may be held in its various angular positions with respect to tube 16 by means of the pin or bolt 48 extending through one of the openings 30, through collar 46 and through a registering opening 32.

A mount assembly 50 is selectively longitudinally secured to tube 38 adjacent the rearward end thereof by U-bolts 52 or other means. Mount assembly 50 is comprised of a pair of spaced-apart and upstanding plates 54 and 56. Plates 54 and 56 have a plurality of radially spaced-apart and aligned pin openings 58 and 59 formed therein respectively. An elongated tube 60 has its lower end pivotally secured to plates 54 and 56 by a pivot pin or bolt 62 which extends through a pin opening in plate 54, through collar or sleeve 63, which is secured to the lower end of tube 60, and through a pin opening 59 formed in plate 56. The upper end of tube 60 is provided with a through opening 64. Post 60 may be selectively positioned in various angular positions with respect to plates 54 and 56 by extending the bolt or pin 65 through one of the openings 58 in plate 54, through the collar 63 and through one of the registering openings 59 in plate 56.

The numeral 66 refers to the cargo support structure of this invention. Tube 60, which is adapted to selectively rotatably receive tube 67 of support structure 66 which has a plurality of vertically spaced-apart through openings 68 formed therein. Tube 67 also has a plurality of through openings 68′ formed therein which are at a 90 degree angle with respect to vertically spaced-apart openings 68.

The vertically spaced-apart openings 68 and 68′ permit the support structure to be raised or lowered with respect to post 60 so that the support structure 66 may be positioned at the same level as the tailgate of the vehicle to enable long items such as lumber, etc. to be supported on the vehicle and on the support structure 66. Support structure 66 may also be rotated 90 degrees with respect to post 60.

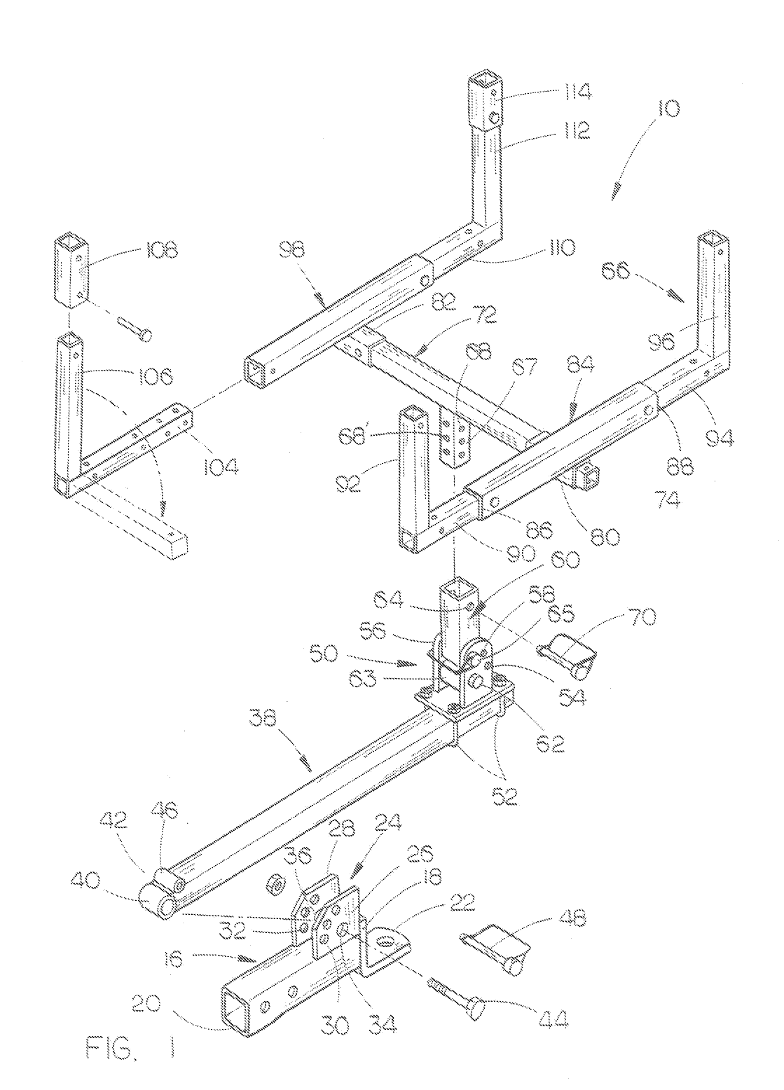

Tube 67 is maintained in tube 60 by means of the pin 70 extending through the through opening 64 in tube 60 and the through openings 68 or 68′. An elongated tube 72 having ends 74 and 76, is welded or otherwise secured, intermediate its length, to tube 67 in a transverse relationship as seen in the drawings. Tube 67 may be selectively secured to mount 50 so that the longitudinal axis of tube 72 is transversely disposed with respect to the longitudinal axis of tube 38 (FIG. 1) or rotated 90 degrees with respect to mount assembly 50 so that the longitudinal axis of tube 72 is parallel to the longitudinal axis of the tube 38.

A short tube or sleeve 80 is longitudinally adjustably secured to end 74 of tube 72 and a short tube or sleeve 82 is longitudinally adjustably secured to end 76 of tube 72. An elongated tube 84, having ends 86 and 88, is secured, intermediate its length to tube 80 so as to be transversely disposed thereto.

Tube 90 is selectively slidably received in end 86 of tube 84. Tube 92 is secured to the outer end of tube 90 and extends transversely with respect thereto. Tube 90 may be selectively positioned in tube 84 so that tube 92 extends upwardly with respect to tube 84 or to extend horizontally inwardly with respect to tube 84.

Tube 94 is slidably adjustably received in end 88 of tube 84 and has a tube 96 secured to the outer end thereof which extends transversely with respect thereto. Tube 94 may be selectively rotated with respect to tube 84 so that the tube 96 extends upwardly from tube 94 or so that tube 96 extends inwardly in a horizontal manner with respect to tube 84.

An elongated tube 98, having ends 100 and 102, is welded or otherwise secured, intermediate its length, to tube 82 in a transverse relationship as seen in the drawings. Tube 104 is longitudinally slidably received in end 100 of tube 98 and has a tube 106 secured to the outer end thereof which extends transversely therefrom. Tube 104 is selectively rotatably mounted in tube 98 so that the tube 104 may extend either upwardly or inwardly towards the other side of the cargo carrier. A collar or tube 108 is selectively secured to the outer end of the tube 106.

A tube 110 is longitudinally selectively and rotatably received in end 102 of tube 98 and has a tube 112 secured to the outer end thereof which extends transversely therefrom. Tube 110 may be selectively rotatably mounted in end 102 of tube 98 so that the tube 112 either extends upwardly or horizontally inwardly towards the other side of the cargo carrier. A sleeve or tube 114 is selectively secured to the outer end of tube 112.

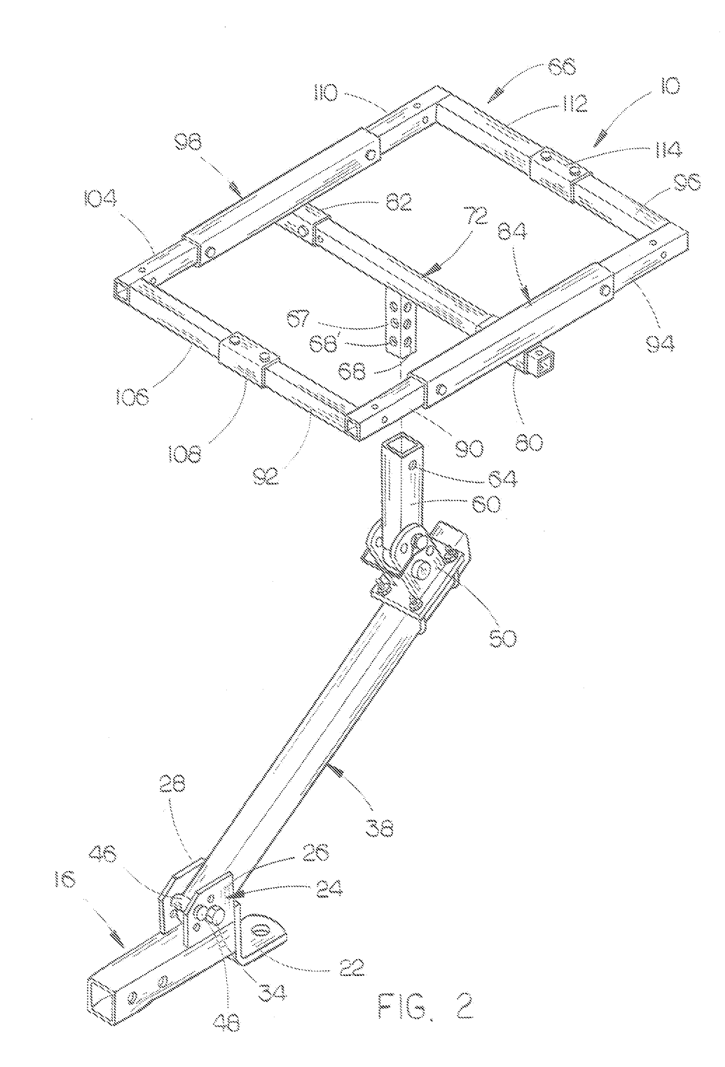

As seen in FIG. 1, the tubes 90, 94, 104 and 110 may be selectively rotatably positioned in the ends of the tubes 84 and 98 so that the tubes 92, 96, 106 and 112 may extend upwardly therefrom to enable cargo to be positioned therebetween and secured thereto. The fact that the second tube 38 may be selectively pivotally secured to the first mount 24 enables the cargo carrier support to be raised with respect to the vehicle hitch so that the cargo on the device is elevated above the area where it will not be subjected to road grime. As seen in FIG. 2, the cargo supporting structure 66 may be moved to a folded position with the tube 108 securing tubes 92 and 106 together in a horizontally disposed position and with the tube 114 securing the tubes 96 and 112 in the horizontal position. Further, it can be seen that the tubes 90 and 94 are selectively slidably received by the tube 84 and that the tubes 104 and 110 are selectively slidably received by the tube 98.

FIG. 4 illustrates the position which the cargo supporting structure 66 may be raised above the tailgate 15.

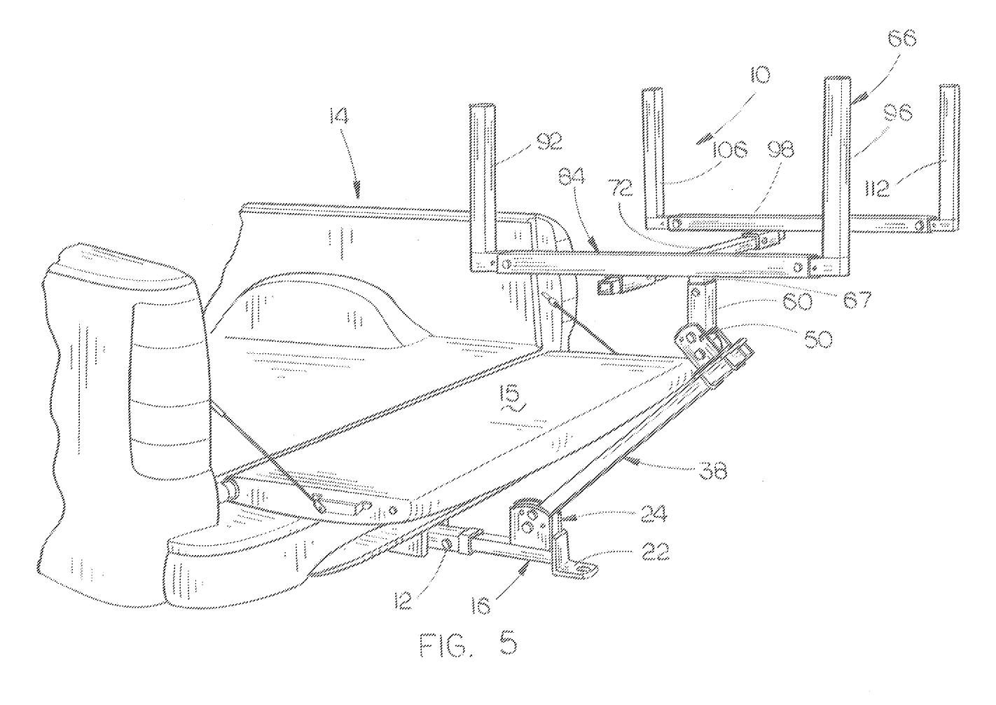

FIG. 5 illustrates the situation wherein the cargo carrier support structure 66 is partially positioned above the tailgate 15 much like that shown in FIG. 4 except that the tubes 108 and 114 have been removed from the tubes 106 and 112.

In FIG. 6, the tube 38 is in a vertically disposed position so that the forward end of the cargo carrier support structure 66 is positioned above the rearward end of the vehicle.

FIG. 7 illustrates a scenario wherein the tube 38 is in a horizontally disposed position so that the cargo carrier support structure 66 may be used to support long members such as lumber or the like which are positioned in the bed of the truck and on the tail gate 15 and supported by the cargo carrier support structure 66.

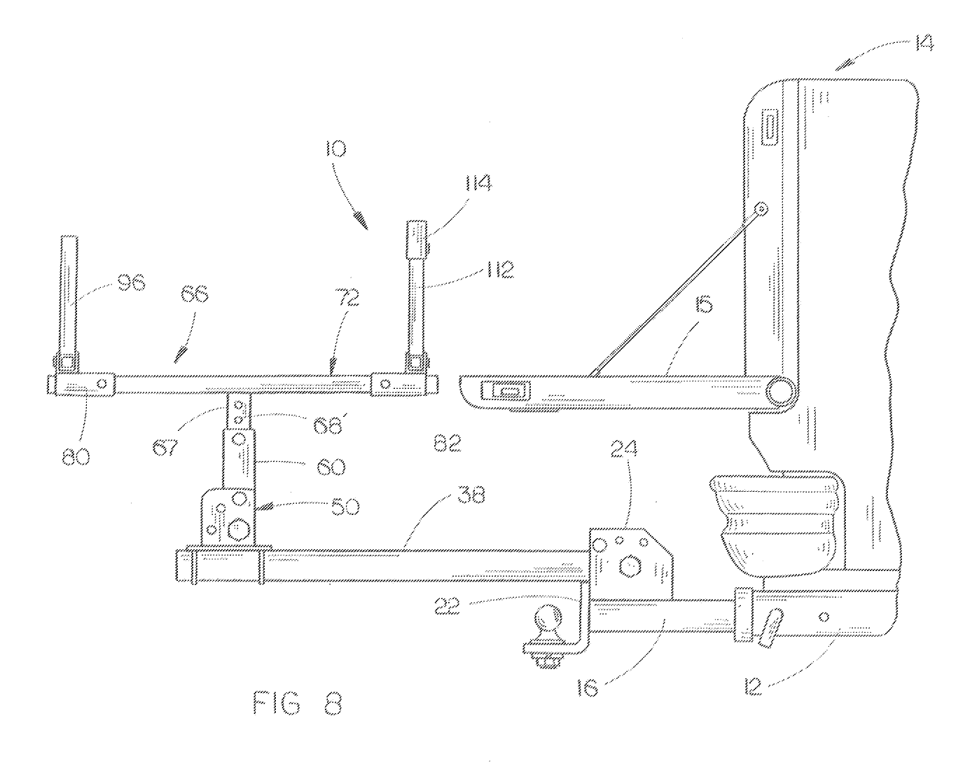

FIG. 8 is a similar view to FIG. 7 except that the cargo carrier support 66 has been rotated 90 degrees from the position of FIG. 7.

Thus it can be seen that a novel cargo carrier has been provided which may be attached to the receiver tube of a vehicle trailer hitch and which enables the cargo to be positioned in various positions through the pivotal connection of the tube 38 to the mount 24, the pivotal movement of the tube 60 with respect to the mount 50, the selective rotatable connection of the tube 67 with the tube 60 and the selective pivotal movement of the tubes 92, 96, 106 and 112.

The cargo carrier support 66 may be folded flat as seen in FIG. 2. The cargo carrier support 66 may also be removed from the tube 60 so that a bike rack may be mounted on the upper end of the tube 60.

The cargo carrier of this invention is quickly and easily mounted on the vehicle hitch, is easily assembled and disassembled as needed. Therefore, it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. In combination with a vehicle having a rearwardly extending and horizontally disposed hitch receiver tube secured thereto, comprising:
an elongated first tube, having forward and rearward ends, selectively received in and detachably secured to the hitch receiver tube;
a first mount structure secured to said first tube adjacent said rearward end thereof which extends upwardly therefrom;
an elongated second tube having first and second ends;
said first end of said second tube being selectively angularly adjustably pivotally secured to said first mount structure about a horizontal axis which is transverse to the longitudinal axis of said first and second tubes;
a second mount structure secured to said second tube adjacent said second end thereof and which extends upwardly therefrom;
and a cargo support structure selectively adjustably pivotally secured to said second mount.

2. The combination of claim 1 wherein said second tube is selectively pivotally movable between a horizontally disposed position, a vertically disposed position, and angular positions therebetween.

3. The combination of claim 1 wherein said cargo support structure is also selectively rotatably secured to said second mount.

4. The combination of claim 1 wherein said cargo support structure includes a plurality of upstanding support members which are selectively movable between an upstanding vertically disposed position and a horizontally disposed folded position.

5. The combination of claim 1 wherein said cargo support structure includes: (1) a third elongated tube, having first and second ends, which is operatively selectively secured to said second mount; (2) a fourth elongated tube, having first and second ends, secured, intermediate its length, to said third tube in a transverse manner; (3) a fifth upstanding tube secured to said first end of said fourth tube; (4) a sixth upstanding tube secured to said second end of said third tube; (5) a seventh elongated tube, having first and second ends, secured, intermediate its length, to said second end of said third tube in a transverse manner; (6) an eighth upstanding tube secured to said first end of said seventh tube; (7) and a ninth upstanding tube secured to said second end of said seventh tube.

6. The combination of claim 5 wherein said fifth, sixth, eight and ninth upstanding tubes are selectively movable from an upstanding position to a folded position.

7. The combination of claim 5 wherein said third tube is rotatable between first and second positions with respect to said second mount; said third tube being transversely disposed with respect to said second tube when in said first position, said third tube being parallel to said second tube when in said second position.

8. The combination of claim 6 wherein said fifth and eighth tubes are connected together when in said folded positions and wherein said sixth and ninth tubes are connected together when in said folded position.

9. The combination of claim 1 wherein said cargo support structure comprise a bike rack.

10. The combination of claim 1 wherein the vehicle is a motorcycle.

11. The combination of claim 1 wherein said cargo support structure is selectively vertically adjustably secured to said second mount.

12. In combination with a vehicle having a rearwardly extending and horizontally disposed hitch receiver tube secured thereto, comprising:
an elongated first tube, having forward and rearward ends, with the rearward end thereof selectively received in and detachably secured to the hitch receiver tube;
a first mount structure secured to said first tube adjacent said rearward end thereof and which extends upwardly therefrom;
an elongated second tube having forward and rearward ends;
said forward end of said second tube being selectively adjustably pivotally secured to said first mount structure about a horizontal axis which is transverse to the longitudinal axis of said first and second tubes;
a second mount structure secured to said second tube adjacent said rearward end thereof and which extends upwardly therefrom;
a third elongated tube having first and second ends;
said first end of said third tube being selectively adjustably pivotally secured to said second mount;
a fourth elongated tube having first and second ends;
said first end of said fourth tube being selectively rotatably secured to said third tube;
a fifth elongated tube having first and second ends;
said fifth elongated tube being secured, intermediate said first ands second ends thereof, to said second end of said fourth tube so as to be transversely disposed with respect to said fourth tube;
a sixth tube, having first and second ends;
said sixth tube, being secured intermediate its first and second ends thereof, to said first end of said fifth tube so as to be disposed transversely thereto;
a seventh tube having first and second ends;
said first end of said seventh tube being selectively rotatably secured to said first end of said sixth tube so as to extend therefrom in a parallel manner thereto;
an eighth tube having first and second ends;
said first end of said eighth tube being secured to said second end of said seventh tube and which extends transversely therefrom;
a ninth tube having first and second ends;
said first end of said ninth tube being selectively rotatably secured to said second end of said sixth tube so as to extend therefrom in a parallel manner thereto;
a tenth tube having first and second ends;
said first end of said tenth tube being secured to said second end of said ninth tube and which extends transversely therefrom;
an eleventh elongated tube having first and second ends;
said eleventh elongated tube being secured, intermediate said first and second ends thereof, to said second end of said fifth tube so as to be transversely disposed with respect to said fifth tube;
a twelfth tube having first and second ends;
said first end of said twelfth tube being selectively rotatably secured to said first end of said eleventh tube so as to extend therefrom in a parallel manner thereto;
a thirteenth tube having first and second ends;
said first end of said thirteenth tube being secured to said second end of said twelfth tube and which extends transversely therefrom;
a fourteenth tube having first and second ends;
said first end of said fourteenth tube being selectively rotatably secured to said second end of said eleventh tube so as to extend therefrom in a parallel manner thereto;
a fifteenth tube having first and second ends;
said first end of said fifteenth tube being secured to said second end of said fourteenth tube and which extends transversely therefrom.

13. The combination of claim 12 wherein said fourth tube is selectively rotatably adjustably secured to said third tube so as to be rotatably movable between first and second positions with respect to said third tube, said fifth tube being transversely disposed with respect to said second tube when said fourth tube is in said first position and whereby said fifth tube is parallel to said second tube when said fourth tube is in said second position.

14. In combination with a vehicle having a rearwardly extending and horizontally disposed hitch receiver tube secured thereto, comprising:
an elongated first tube, having forward and rearward ends, selectively received in and detachably secured to the hitch receiver tube;
a first mount structure secured to said first tube adjacent said rearward end thereof which extends upwardly therefrom;
an elongated second tube having first and second ends;
said first end of said second tube being selectively angularly adjustably pivotally secured to said first mount structure about a horizontal axis which is transverse to the longitudinal axis of said first and second tubes;
a second mount structure secured to said second tube adjacent said second end thereof and which extends upwardly therefrom;
and a bike rack selectively secured to said second mount.

15. The combination of claim 14 wherein the bike rack is selectively adjustably secured to said second mount.
